(19) United States
(12) Patent Application Publication
(10) Pub. No.: US 2008/0218432 A1
(43) Pub. Date: Sep. 11, 2008

(54) Image display system and method

(75) Inventor: Koichiro Ota, Omachi-shi (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 12/075,034

(22) Filed: Mar. 8, 2008

(30) Foreign Application Priority Data
Mar. 9, 2007 (JP) 2007-060301

(51) Int. Cl. G09G 5/00

(52) U.S. Cl. 345/1.3

(57) ABSTRACT

The disclosure is directed to image display system and apparatus. In one example, a system comprises a plurality of display apparatus each having a display area. The display apparatus are configured to display images based on image information supplied from a processing unit. The processing unit is configured to receive information descriptive of the display area for each of the plurality of display apparatus, manage integrated screen area information for the plurality of display apparatus based at least on the information descriptive of the display area for each of the plurality of display apparatus, and generate image information from the integrated screen area information for each of the plurality of display apparatus regardless of whether each of the display apparatus is operatively connected to the processing unit.

### CROSS-REFERENCE

The present application claims priority from Japanese Patent Application No. 2007-060301 filed on Mar. 9, 2007, which is hereby incorporated by reference in its entirety.

### BACKGROUND

Among multi-screen display apparatus, a multi-screen display apparatus which, even in the event that some of display apparatus or display controllers are at a stop due to a maintenance, a failure or the like, eliminates a deficiency of image information by displaying all screens without omission, and improves a reliability as the multi-screen display apparatus, has been known (for example, refer to JP-A-8-6532). Specifically, a whole screen reducer/allotter and a reduction setter are provided between a whole screen generator and each display controller. The whole screen reducer/allotter includes: a whole screen memory which stores a whole screen from the whole screen generator; a reduction setting memory which stores a reduction method set by the reduction setter with a stopped place avoided; a whole screen reducer; a reduced screen memory which stores a reduced screen; and a screen information allotter which allots the reduced screen to a portion in which are combined a sound display controller and display apparatus.

Meanwhile, a technology arranged in such a way as to enable a superimposed display of a plurality of screens, and increase a usability of the screen to improve an operating efficiency has been known (for example, refer to JP-A-5-46237). Specifically, the technology includes at least: a storage unit which stores screen information including a switch item; a display unit which displays the screen information; an operating unit which includes the switch item; and a processing unit which carries out a control of each unit and data processing. The technology is one in which, in an operation display panel connected to an external controller via an interface circuit, when screen data are sent, together with a predetermined command, from the external controller, the command is decoded, it is determined whether or not a display corresponding to it is possible, and the screen received is displayed in place of a screen currently being displayed, displayed simply superimposed on the screen currently being displayed, or displayed reduced and superimposed. By means of the technology, the simply superimposed display, and the reduced/superimposed display, of the plurality of screens are made possible in accordance with the command from the external controller and a current display condition.

However, as the technology of JP-A-8-6532 is the multi-screen display apparatus arranged in such a way as to eliminate the deficiency of the display information in the multi-screen display apparatus, there being no disparity between the display apparatus, temporarily being stopped for the reason of a failure or the like, and the sound display apparatus, and there being a relationship in which the nearly evenly rated multi-screens complement each other, the technology is not one which fulfills a rehearsal function or a monitor function by means of a main (sub-) display apparatus integral with, or already set in, a personal computer before connecting the sub-(main) display apparatus to the personal computer.

Also, the technology of JP-A-5-46237, being an operation display panel of a mechanical apparatus or the like in which the simply superimposed display and reduced/superimposed display of the plurality of screens are made possible in accordance with the command from the external controller and the current display condition, especially, an operation display panel which enables a superimposed display of the screens, is not one which corresponds to the rehearsal function or the monitor function.

That is, the technologies disclosed in JP-A-8-6532 and JP-A-5-46237 are not arranged in such a way that the personal computer recognizes the correspondent regardless of whether or not the display apparatus is connected to the personal computer, or whether or not the display apparatus is in the operable condition, and that, even in the event that the display apparatus is not communicating with the personal computer, by supposing a condition in which an operable display apparatus is connected thereto, it is possible to fulfill the rehearsal function or the monitor function.

### SUMMARY

An image display system according to certain embodiments includes: a personal computer; a plurality of display apparatus which display images based on image information supplied from the personal computer; and a communication pathway which connects the personal computer and the display apparatus. A function is provided in which the personal computer, by carrying out unique informational communication in connection with the display apparatus, shares screen area information which is display contents of all a plurality of screens, and regardless of a possibility or otherwise of communication of the personal computer with some of the display apparatus, the personal computer side ascertains what image information is to be displayed on the plurality of display apparatus.

By sharing the image area information, the personal computer may recognize the correspondent regardless of whether or not the display apparatus is connected to the personal computer, or whether or not the display apparatus is in an operable condition, that is, of the possibility or otherwise of communication with the display apparatus, and even in the event that the display apparatus is not communicating with the personal computer, by supposing the condition in which an operable display apparatus is connected thereto, it is possible to fulfill the rehearsal function or the monitor function.

Also, in accordance with certain embodiments, the personal computer may include: a screen area management subsystem; a display apparatus disposition information storage unit which reads and freely stores display apparatus disposition information under the management of the screen area management subsystem; a first display subsystem which creates image information compatible with a first display apparatus under the management of the screen area management subsystem; a second display subsystem which creates image information compatible with a second display apparatus under the management of the screen area management subsystem; a screen switching subsystem which switches between displaying image information, which should be displayed on one of the plurality of display apparatus, directly on the one display apparatus, and displaying it on another display apparatus; and a reduced screen creation subsystem which, being inserted in a pathway through which the informational communication is carried out from the second display subsystem to the first display subsystem in accordance with a selection of the screen switching subsystem, edits the image information in such a way as to reduce a screen size.

In accordance with certain embodiments, the screen area management function of the personal computer reads the display apparatus disposition information stored in the display apparatus disposition information storage unit under its management, and the second display subsystem creates the image information compatible with the second display apparatus under the management of the screen area management subsystem. Also, in a pathway through which the image information created by the second display subsystem is informationally communicated to the first display subsystem, the reduced screen creation subsystem, in accordance with the selection of the screen switching subsystem, edits the image information in such a way as to reduce the screen size. The image information edited in this way is displayed reduced on the first display apparatus.

Also, in accordance with certain embodiments, a virtual screen display subsystem is inserted in place of the screen switching subsystem, and the virtual screen display subsystem is a function which, even in the event that the second display apparatus is in an unconnected condition with respect to the personal computer or in a non-operating condition, creates virtual screen information in which it is supposed that the second display apparatus is in a condition in which it is connected to the personal computer and displays the image.

Also, in accordance with certain embodiments, even in the event that the second display apparatus is in the unconnected condition with respect to the personal computer, or in the non-operating condition, the virtual screen display subsystem may create the virtual screen information in which it is supposed that the second display apparatus is in the condition in which it is connected and displays the image.

By using the virtual screen information created by the virtual screen display subsystem, as a virtual screen can be displayed reduced on a display apparatus which is connected solely to the personal computer and operable, it is possible to fulfill the rehearsal function or the monitor function.

Also, in accordance with certain embodiments, at least one of the plurality of display apparatus is a projector. By so doing, as well as a portability and/or a large screen display advantage of the projector being produced, as the rehearsal function or the monitoring function is fulfilled, it is possible, to increase a reliability of effect advantages in an actual screen display.

Also, in accordance with certain embodiments, it is also possible, as the communication pathway, to interpose a direct connection using a USB port. By so doing, the use of the USB port facilitating a connection setting between the instruments, it is possible to increase convenience.

### BRIEF DESCRIPTION OF THE DRAWINGS

Various embodiments are described with reference to the accompanying drawings, wherein like numbers reference like elements.

FIG. 1 is a block diagram showing a configuration of an image display system in accordance with a first embodiment.

FIG. 2 is a block diagram showing a configuration of an image display system in accordance with a second embodiment.

FIG. 3 is a flowchart showing an operating procedure of a screen switching subsystem in the image display system in accordance with the second embodiment.

FIG. 4 is a block diagram showing an image display system in accordance with a third embodiment.

FIG. 5 is a block diagram illustrating the components of an exemplary computer.

### DESCRIPTION OF EXEMPLARY EMBODIMENTS

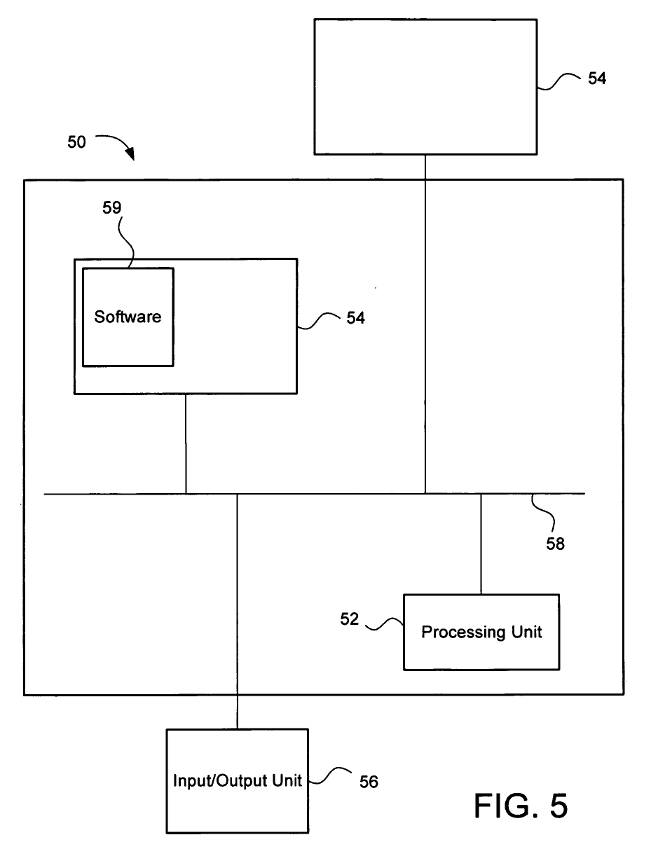

An image display system in accordance with certain embodiments provides a system for operating a plurality of image display apparatus (hereafter referred to as “display apparatus”) with a computer at its core. The computer at the core, as heretofore known, functions by hardware and software (programs) cooperating. With reference to FIG. 5, a computer 50 may comprise a processing unit 52(e.g., a CPU), a storage unit 54 (e.g., internal or external storage such as a RAM, a ROM, a hard disk, or the like) and an input/output unit 56 (e.g., a keyboard, display apparatus or the like) communicatively coupled to one another by a bus 58. Also, software 59, such as software executed by the hardware, communication browsing software such as a browser, various kinds of driver software for causing the display apparatus and a printer to operate, and other application software may be stored in advance in the storage unit 54, or prepared in such a way that they can be read from an exterior source.

Hereafter, a description will be given, while referring to the drawings, of the image display system according to certain embodiments. A redundant description is avoided by giving the same reference numerals to the same functions in the drawings.

Many of the functional units described in this specification have been explicitly labeled as subsystems, in order to more particularly emphasize their implementation independence. For example, a subsystem may be implemented as a hardware circuit comprising custom VLSI circuits or gate arrays, off-the-shelf semiconductors such as logic chips, transistors, or other discrete components. A subsystem may also be implemented in programmable hardware devices such as field programmable gate arrays, programmable array logic, programmable logic devices or the like.

Subsystems may also be implemented in software for execution by various types of processors. An identified subsystem of executable code may, for instance, comprise one or more physical or logical blocks of computer instructions which may, for instance, be organized as an object, procedure, or function. Nevertheless, the executables of an identified subsystem need not be physically located together, but may comprise disparate instructions stored in different locations which, when joined logically together, comprise the subsystem and achieve the stated purpose for the subsystem.

Indeed, a subsystem of executable code may be a single instruction, or many instructions, and may even be distributed over several different code segments, among different programs, and across several memory devices. Similarly, operational data may be identified and illustrated herein within subsystems, and may be embodied in any suitable form and organized within any suitable type of data structure. The operational data may be collected as a single data set, or may be distributed over different locations including over different storage devices, and may exist, at least partially, merely as electronic signals on a system or network.

### First Embodiment

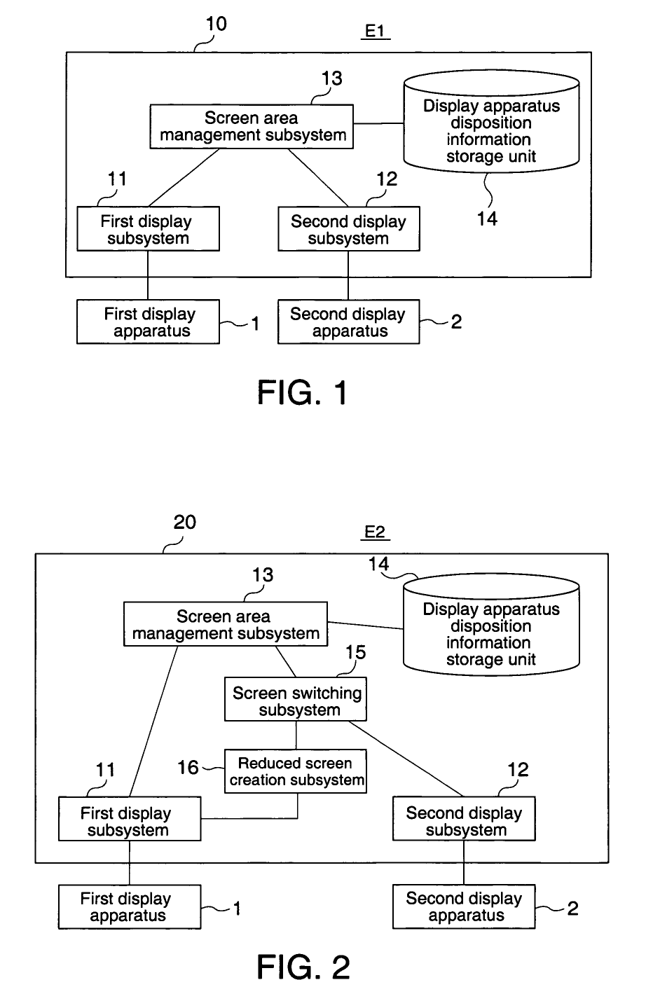

FIG. 1 is a block diagram showing a configuration of an image display system E1 in accordance with a first embodiment. In the image display system E1, a plurality of display apparatus (hereafter referred to as a “first display apparatus”, a “second display apparatus” or also referred to simply as “display apparatus”) 1, 2 . . . identified by prefixing first, second . . . thereto are communicatively coupled in such a way that they can display images based on image information supplied from a computer (hereafter, referred to as a “PC”) 10 via a communication pathway. In FIG. 1, functions relating to the image displays being extracted are illustrated in the block diagram, while some of the components of the PC 10 are omitted from the description.

To summarize, the image display system E1 shown in FIG. 1 comprises the PC 10, and the first display apparatus 1 and the second display apparatus 2, connected to the PC 10. Although, in the embodiments, as illustrated, the first display apparatus 1 is a liquid crystal display device integrated with a notebook PC, and the second display apparatus 2 is a projector, the display apparatus may also be other display devices. The display apparatus 1, 2 . . . , normally having a screen display area and setting information as unique information, cannot display the images normally until they communicate the unique information to the PC 10 to cause the PC 10 to recognize their existence. It is also possible to assume a usage aspect such as to acquire the unique information in advance on the PC 10 side, and provide it for a rehearsal prepared for an actual screen display.

Also, various functions shown in FIG. 1 and other figures may be activated by executing the programs appropriately by means of the common hardware, rather than by means of components configured only of hardware independent of one another. The image display system E1 is configured in such a way as to operate by a first display subsystem 11, a second display subsystem 12 and a display apparatus disposition information storage unit 14, communicatively coupled radiating from a screen area management subsystem 13 in the PC 10 shown in FIG. 1, being activated.

Also, a more detailed aspect of the informational connection, and operations, of the components are as follows. An instruction from a user using the image display system E1 is received and processed by the screen area management subsystem 13 of the PC 10 into which it is input from the input/output unit such as a keyboard or the like. A display apparatus disposition information storage unit 14, communicatively coupled under the management of the screen area management subsystem 13, reads and freely stores display apparatus disposition information relating to areas, in which the display apparatus 1 and 2 are allowed to occupy screens, a layout and the like. Also, as the display apparatus disposition information, various kinds of form are stored in the display apparatus disposition information storage unit 14. The various kinds of form can also be subjected to information processing in such a way as to be read in accordance with an instruction from the user by means of a very simple key operation, or semi-automatically read within a processing range of the screen area management subsystem 13, and used while being edited appropriately.

The first display apparatus 1 is communicatively coupled to the screen area management subsystem 13 via the first display subsystem 11. At the same time, the second display apparatus 2 is also communicatively coupled to the screen area management subsystem 13 via the second display subsystem 12. The image display system E1 can, through these information pathways, edit the image information to be displayed on the display apparatus 1 and 2 in accordance with the instruction from the user, and display it as the images.

The first display subsystem 11 may include driver software which, as well as creating image information compatible with the first display apparatus 1, causes the first display apparatus 1 to operate, under the management of the screen area management subsystem 13. In the same way, the second display subsystem 2 may include driver software which, as well as creating image information compatible with the second display apparatus 2, causes the second display apparatus 2 to operate, under the management of the screen area management subsystem 13. With this kind of configuration, the screen area management subsystem 13 functions in such a way as to determine the areas, in which the display apparatus 1 and 2 are allowed to occupy the screens, the layout and the like, in order for the user to optionally use the first display apparatus 1 and the second display apparatus 2.

To describe in detail, the screen area management subsystem 13 manages screen area information which is display contents relating to a whole screen in which a plurality of the screens are integrated, it is possible, in the screen area management subsystem 13, to process the screen area information, with display apparatus disposition information for arranging the screen area information appropriately, and displaying it on the display apparatus 1 and 2, added thereto, too. The display apparatus disposition information includes information which determines how the images which should be displayed independently on the display apparatus 1 and 2 have editing aspects, such as vertical and horizontal dispositions and a connection order, allotted to the display apparatus 1 and 2, and are communicatively coupled. Based on the display apparatus disposition information, by instructing the first display subsystem 11 and the second display subsystem 12, which drive the plurality of display apparatus 1 and 2 respectively, to display a portion or a whole of the whole screen, it is possible to carry out a display desired by the user.

As a specific usage aspect of the image display system E1, for example, it is also possible to display a left half of a single image on the first display apparatus 1, and display the remaining right half on the second display apparatus 2. Alternatively, a whole of the single image is displayed on the first display apparatus 1, and an image subjected to an editing process, such as a partial closeup or reduction, is displayed on the second display apparatus 2. In certain embodiments, while the first display apparatus 1 attached integrally to a notebook PC of a lecturer is exclusively used as a monitor for the lecturer himself, a large screen display projector provided for a lecture participant's viewing is exclusively used as the second display apparatus 2. In this case, it is also possible to appropriately superimpose a lecture note or the like in accordance with an instruction from the lecturer who is the user, and display it on the first display apparatus 1 as the monitor.

This kind of image display system E1 will be described broadly in the following way. The screen area management subsystem 13 of the PC 10, by communicating the unique information relating to the plurality of display apparatus 1 and 2, shares the screen area information, to be displayed on the plurality of display apparatus 1 and 2, on the PC 10 side. The screen area information can be acquired even in the event that not all the plurality of display apparatus 1 and 2 are connected to the PC 10. For example, it is also possible to acquire it from the first and second display subsystems 11 and 12 inside the PC 10. Consequently, in the screen area management subsystem 13, regardless of a possibility or otherwise of communication of the PC 10 with one display apparatus 2, the PC 10 side ascertains what image information is to be displayed on the plurality of the display apparatus 1 and 2.

According to the image display system E1, as well as sharing the image area information to be displayed, it recognizes whether one of the plurality of display apparatus 1 and 2 is operatively connected to the PC 10 (i.e. connected to the PC 10 or in an operable condition). By so doing, the PC 10 can recognize the display apparatus 2, which is the correspondent, regardless of the possibility or otherwise of communication with the one display apparatus 2. By so doing, even in the event that the display apparatus 2 is not communicating with the PC 10, the image display system E1, after supposing a condition in which the operable display apparatus 2 is connected thereto, can fulfill a rehearsal function or a monitoring function by means of the display apparatus 1.

The “monitor display” may be, for example, an image display arranged in such a way that only the lecturer can confirm an actual screen which the lecturer is to display for the lecture participant, without showing it to the lecture participant. The monitor display having the “rehearsal function” required before the actual screen display as its main object, it is also possible, as its sub-object, to realize a simultaneous monitoring of the actual screen during the actual screen display. The monitor display not necessarily being limited to the rehearsal function and the simultaneous monitoring function, there is also a utilization method which displays an expository writing or the like which is not included on the actual screen.

### Second Embodiment

FIG. 2 is a block diagram showing a configuration of an image display system E2 in accordance with a second embodiment. In FIG. 2, similar to FIG. 1, only functions relating to image displays of the display apparatus 1 and 2 and a PC 20 connectable thereto being extracted as the block diagram are shown, while some components of the PC 20 are omitted from the description.

As shown in FIG. 2, the image display system E2 according to certain embodiments is configured on the PC 20 in which comprise a screen switching subsystem 15 and a reduced screen creation subsystem 16, in addition to the PC 10 in the image display system E1 shown in FIG. 1. The image display system E2 which is the second embodiment is a system which, using the screen switching subsystem 15 and the reduced screen creation subsystem 16, even when the second display apparatus 2 is turned off or not connected to the PC 20, enables a reduced screen of an image, which should be displayed on the second display apparatus 2, to be created, edited so as to be inset in, and displayed on, the first display apparatus 1 which is already displaying an image.

The screen switching subsystem 15 is a switching function which switches the image being displayed on the second display apparatus 2 in such a way as to be cut into a portion of the display image on the first display apparatus 1 in accordance with the user's operation. Furthermore, a connection detection function (not shown) which detects whether the second display apparatus 2 is being connected to the PC 20 or is in an unconnected (or off) condition is also included in the screen switching subsystem 15. The reduced screen creation subsystem 16 is inserted in a pathway through which the informational communication is carried out from the second display subsystem 12 to the first display subsystem 11 in accordance with a selection of the screen switching subsystem 15. The reduced screen creation subsystem 16, being a function which acquires an image display which should be displayed, and displays a reduced screen thereof, is a function which realizes a reduction ratio of the screen displayed on each display apparatus 1 and 2 in accordance with the user's desire.

In the image display system E2, the selection function of the screen switching subsystem 15 enables the monitor display of the image cut into the display image on the first display apparatus 1 in such a way as to realize a reduction ratio and an inset layout, which are desired by the user, by means of the reduced screen creation subsystem 16. Furthermore, based on a result of the detection of the connection detection function included in the screen switching subsystem 15, even without the user's operation, it is also possible to switch an edited image obtained by automatically reducing the image to be displayed on the second display apparatus 2 in the unconnected condition, or the like, in such a way as to be cut into a portion of the display image on the connected first display apparatus 1.

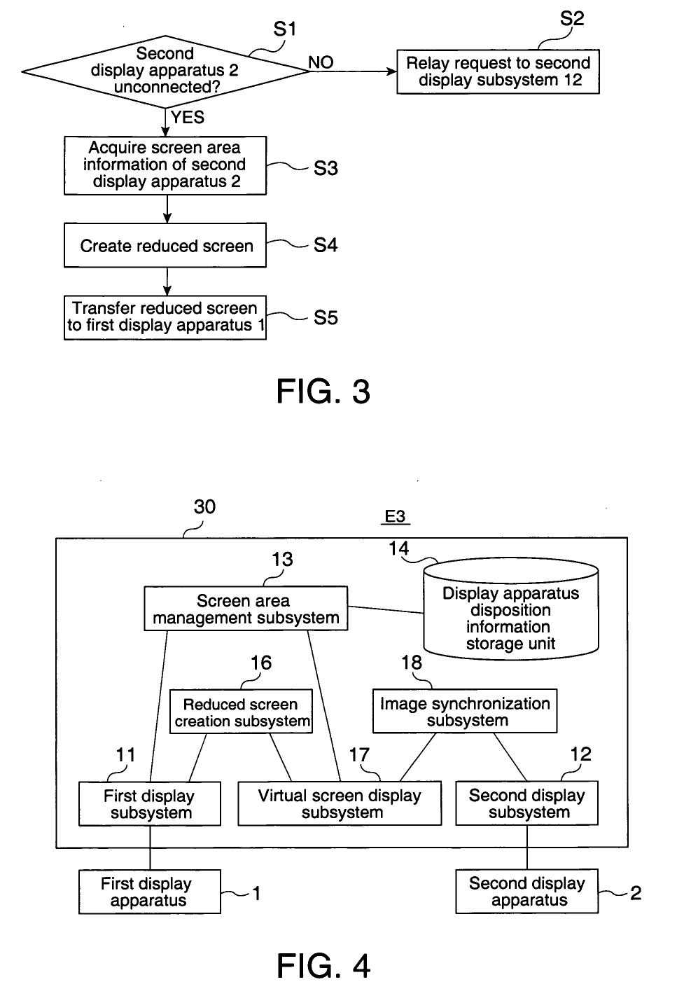

FIG. 3 is a flowchart showing an operating procedure of the screen switching subsystem 15 in the image display system E2 in accordance with certain embodiments. To describe FIG. 3 simply, the operating procedure of the screen switching subsystem 15 includes a display apparatus non-connection determination step (S1), a relay request step (S2), a screen area information acquisition step (S3), a reduced screen creation step (S4), and a reduced screen transfer step (S5).

As illustrated, it is determined, by the display apparatus non-connection determination step (S1), whether the second display apparatus 2 is not operatively connected to the PC 20 (i.e. is unconnected from the PC 20 or in a non-operating condition). If the display apparatus determination step result is No (S1), and it is determined that the second display apparatus 2 is connected to the PC 20 and operable, the relay request step (S2) is executed and, by relaying an image requested by the user directly to the second display subsystem 12, the process of the screen switching subsystem 15 is finished. That is, the display function 12 displays contents, which are to be displayed by the second display apparatus 2, without amendment.

However, if the display apparatus non-connection determination step result is Yes (S1), and it is determined that the second display apparatus 2 is in the condition in which it is not connected to the PC 20 (or the off condition), the process proceeds to the screen area information acquisition step (S3), and image area information to be displayed on the second display apparatus 2 is acquired. In certain embodiments, the screen area information of the second display apparatus 2 is displayed reduced in such a way as to be inset in a portion of the display screen on the first display apparatus 1. In such embodiments, the reduced screen creation step (S4) is executed and, based on the screen area information to be displayed on the display apparatus 2, information for forming a reduced screen is created.

After this, the reduced screen transfer step (S5) is executed and, by the reduced screen information created being transferred to the first display apparatus 1, the reduced screen is displayed in such a way as to be inset in a designated portion of the display screen on the first display apparatus 1. The process of the screen switching subsystem 15 is completed according to this kind of operating procedure. The designated portion used herein is a rectangular area such as a window screen designated by the user.

With the heretofore described process of the screen switching subsystem 15, even in the event that the second display apparatus 2 is not connected to the PC 20, it is possible, by means of a window display or the like on the connected first display apparatus 1, to confirm the contents of the screen which should be displayed on the second display apparatus 2. Alternatively, by omitting the reduced screen creation step (S4), the reduced screen not being created, the screen displays of the first display apparatus 1 and second display apparatus 2 are merely switched and displayed.

### Third Embodiment

Next, a third embodiment will be described.

FIG. 4 is a block diagram showing a configuration of an image display system E3 in accordance with a third embodiment. The image display system E3, by ascertaining information for a virtual screen display, to be described hereafter, even in the event that the second display apparatus 2 is connected in the process of the image display, can carry out the display while being effectively synchronized with the second display apparatus 2.

As shown in FIG. 4, the image display system E3 is configured by inserting a virtual screen display subsystem 17 and an image synchronization subsystem 18, in place of the screen switching subsystem 15, into the PC 20 in the image display system E2 which is the second embodiment shown in FIG. 3. Also, a connection aspect of the components is as follows.

The first, second and third embodiments have in common that a PC 30 is communicatively coupled to the first display apparatus 1 via the first display subsystem 11 from the screen area management subsystem 13. The virtual screen display subsystem 17 and the screen synchronization function 18 are inserted, in order from the screen area management subsystem 13, between the second display subsystem 12, which operates the second display apparatus 2, and the screen area management subsystem 13. The PC 30 is communicatively coupled to the second display apparatus 2 from the second display subsystem 12.

Also, the reduced screen creation subsystem 16 is inserted between the virtual screen display subsystem 17 and the first display subsystem 11. That is, the image synchronization subsystem 18, the virtual screen display subsystem 17, the reduced screen creation subsystem 16 and the first display subsystem 11 are communicatively coupled, in order from the second display subsystem 12, between the second display subsystem 12 and the first display subsystem 11.

The virtual screen display subsystem 17 virtually carries out an operation as the second display subsystem 12. It is a function which, even in the event that the second display apparatus 2 which should be connected to an end of the second display subsystem 12 is in the unconnected condition or in a non-operating (off) condition, after virtually recognizing that it is a condition in which the second display apparatus 2 is connected and displays the image, creates that virtual screen information. That is, the virtual screen display subsystem 17, although it functions as if the second display apparatus 2 is connected to the end of the second display subsystem 12 which it virtually represents, does not actually have a function of connecting to the second display apparatus 2.

In the image display system E3, by using the virtual screen information created by the virtual screen display subsystem 17, as a virtual screen can be displayed, reduced and inset, on the display apparatus 1 which is connected solely to the PC 30 and operable, the image display system E3 can fulfill the rehearsal function or the monitoring function. That is, in the event that the second display subsystem 12 is not connected to the PC 30, the virtual screen display subsystem 17 uses the reduced screen creation subsystem 16 to reduce display contents virtually drawn on itself, and displays them in the window display or the like on the display apparatus 1 which the user has designated.

Specifically, in the image display system E3, in the event that the display apparatus 2 and the PC 30 are not connected, a reduced screen of the contents of the virtual screen display subsystem 17 is created. Next, the reduced screen is transferred to a designated portion in the display apparatus 1. Herein, the designated portion may be a rectangular area such as the window screen designated by the user. One may also merely switch and display the screen display, rather than creating the reduced screen.

On the other hand, in the event that the display apparatus 2 and the PC 30 are connected, the virtual screen information created by the virtual screen display subsystem 17 is synchronized with the connected display function 12. Consequently, the display apparatus 2 connected to the end of the display function 12 displays the virtual screen information routed through the virtual screen display subsystem 17.

The image synchronization subsystem 18, being a function causing image information, which has the same contents as the image information created by the virtual screen display subsystem 17, to be simultaneously created in the display function 12, is a function for displaying the image information having the same contents on the second display apparatus 2 connected to the PC 30. That is, in the event that the display apparatus 2 is connected, the display function 12 and the image created by the virtual screen display subsystem 17 are synchronized by the image synchronization subsystem 18 interposed between the display function 12 and the virtual screen display subsystem 17.

In this way, a configuration is such that the image created by the virtual screen display subsystem 17 is displayed normally on the display apparatus 2 too. This configuration can be realized easily and at a high speed by a method of copying a memory area configured of RAM or the like of the PC 30, or a similar method. That is, in the event that the display apparatus 2 is not connected, it is possible, using the virtual screen display, to confirm the contents by means of the window display or the like on the first display apparatus 1 connected to the PC 30 while, in the event that the second display apparatus 2 is connected, it is possible to swiftly carry out a display using the display apparatus 2.

The image display system E3 is particularly effective in a system in which the display apparatus 2 and the PC 30 are attachable to and detachable from one another. This is because, even in the event that the display apparatus 2 on which the information should be displayed does not exist, it is possible to create a virtual screen as if the display apparatus 2 exists, and confirm it in a reduced window display or the like on the display apparatus 1. Consequently, it is possible, at a stage before carrying out the connection of the display apparatus 2 and the PC 30, to carry out a rehearsal, supposing a formal display screen after carrying out the connection.

A description will hereafter be given of a more specific usage aspect. In the image display systems E1 to E3 which enable the image display by externally connecting the second display apparatus 2 too, in addition to the first display apparatus 1 integrally attached as in notebook PC's 10 to 30 (the same reference numerals as those of the PC's 10 to 30), apart from the PC's 10 to 30 which can display the images with the plurality of display apparatus 1 and 2 connected thereto, it becomes possible to display different contents on the plurality of display apparatus 1 and 2. By carrying out a free usage such as, for example, displaying a lecture note on the first display apparatus 1 the lecturer has at hand, and a presentation image on the externally added second display apparatus 2, it is possible to improve convenience.

Also, according to the image display system E3, an application of carrying out a display of an enlarged image by connecting a projector 2 (the same reference numeral as that of the second display apparatus 2) to the notebook PC 30 (the same reference numeral as that of the PC 30) for each individual, for example, in a conference in which a presentation is carried out by rotation, in the event that it is desired to display contents of the presentation on a screen of the projector 2, and display a lecture manuscript on a screen 1 (the same reference numeral as that of the first display apparatus 1) of the notebook PC 30, it is possible to provide outstanding convenience. That is, with a heretofore known system having the same object, after connecting the projector 2, it is necessary to swiftly carry out an adjustment or the like of a screen setting in the driver software while observing an image projected onto the projector 2. It is possible to reduce a problem in that, as well as this producing no little wasted time, there has also been a possibility of an accident in which information which it has not originally been desired to show is displayed by mistake.

The image display system E3, according to certain embodiments, may include the following advantages.

1. By acquiring information which should be displayed on the display apparatus 2, among the plurality of display apparatus 1 and 2, which is not connected, and displaying it on the other connected display apparatus 1, it is possible to ascertain the contents of all the screens.

2. By subjecting an image which should be displayed on the unconnected display apparatus 2 to a reduction process, and displaying it inset into a window on the display apparatus 1 connected in advance, it is possible to ascertain an overview of both images in combination with the display contents on the display apparatus 1.

3. In the PC 30 capable of a semi-automatic establishment of the informational connection to the unconnected display apparatus 2, by creating the virtual screen information inside the PC 30 from a stage in which the display apparatus 2 is not connected, the monitor display of the virtual screen is carried out in the display apparatus 1 connected in advance. Subsequently, at the stage at which the connection of the PC 30 to the unconnected display apparatus 2 has been established, it is possible, by using the virtual screen information, to swiftly reflect it in an actual image to be displayed on the display apparatus 2.

Also, by arranging in such a way as to use the projector for at least one of the plurality of display apparatus 1, 2 . . . , the one display apparatus, as well as producing a portability and/or a large screen display of the projector, can fulfill the rehearsal function or the monitoring function. Accordingly, it is possible to increase the reliability of effect advantages in the actual screen display. It is also possible to apply the technology of the image display systems E1 to E3 to software attached to a projector using a device such as a DMD (Digital Micromirror Device: the registered trademark of Texas Instruments, Inc. in the United States).

Then, according to the image display systems E1 to E3 having a USB port (not shown) interposed in the communication pathway, an instrument setting becoming easy by means of a direct instrument connection using the USB port, the convenience can be further increased.

More specifically, by way of a network, or by incorporating the image display systems E1 to E3 in the PC side software in a projector capable of the USB connection, it is possible, without connecting the projector 2, to rehearse and confirm display contents on a plurality of displays 1 and 2 (the same reference numerals as those of the display apparatus 1 and 2) which arise after connecting the projector 2.

By this means, it is possible, without actually connecting the projector, to carry out a setting (a disposition or maximization of the window, a prior disposition of a necessary reference material, or the like) of each kind of software necessary when carrying out an actual presentation. Consequently, as well as a starting of the presentation being made smooth, an advantage of preventing a projection of unnecessary information being brought about, it is possible to increase a customer satisfaction.

The foregoing description shall not be limited to the heretofore described embodiments of a presentation application, as it is possible to produce an advantageous effect in application of connecting the plurality of display apparatus to the PC. For example, an application to a wall display using a plurality of displays can be considered. Also, by displaying the screen display and the virtual screen simultaneously without switching them, it is also possible to remotely monitor, or monitor and confirm, display contents on a display at a remote location.

While specific embodiments and applications have been illustrated and described, it is to be understood that the precise configuration and components disclosed herein is illustrative only and not limiting in any sense. Having the benefit of this disclosure, various modifications, changes, and variations will be apparent to those of ordinary skill in the art without departing from the spirit and scope of the principles disclosed. Thus, to the maximum extent allowed by law, the scope of the invention is to be determined by the broadest permissible interpretation of the following claims and their equivalents, and shall not be restricted or limited by the foregoing description.

What is claimed is:

1. An image display method comprising:
displaying a first image information from a computer on a first display apparatus;
determining whether a second display apparatus is operatively connected with the computer;
if operatively connected, displaying a second image information to the second display apparatus;
if not operatively connected,
acquiring the second image information to be displayed on the second display apparatus, and
displaying the second image information on the first display apparatus.

2. The image display method of claim 1, further comprising:
reducing a screen size of the second image information prior to displaying the second image information on the first display apparatus;
displaying the second image information on the first display apparatus concurrently with the first image information.

3. The image display method of claim 1, wherein:
displaying the second image information on the first display apparatus comprises displaying the second image information in a window on the first display apparatus.

4. The image display method of claim 1, wherein the second display apparatus is a projector and the first display apparatus is a liquid crystal display device integrated with the computer.

5. The image display method of claim 1, further comprising:
receiving information descriptive of a display area for each of the first display apparatus and the second display apparatus;
managing the first image information and the second image information through a screen area management subsystem, the first image information and second image information being, managed as integrated screen area information based on the information descriptive of the display area of the first display apparatus and the second display apparatus; and
processing the screen area information in accordance with display apparatus disposition information.

6. The method of claim 1, further comprising:
creating a virtual screen display representing the second image information to be displayed on the second display apparatus; and
wherein the act of acquiring the second image information comprises acquiring the second image information from the virtual screen display.

7. The method of claim 6, further comprising:
synchronizing the virtual screen display with the second display apparatus if the second display apparatus is connected with the computer.

8. The method of claim 7, further comprising:
reducing a size of the second image information prior to displaying the second image information on the first display apparatus.

9. An image display system comprising:
a processing unit;
a plurality of display apparatus each having a display area, the plurality of display apparatus configured to display images based on image information supplied from the processing unit; and
a communication pathway for communicatively coupling the processing unit and the plurality of display apparatus, wherein
the processing unit is configured to:
receive information descriptive of the display area for each of the plurality of display apparatus,
manage integrated screen area information for the plurality of display apparatus based at least on the information descriptive of the display area for each of the plurality of display apparatus, and
generate the image information from the integrated screen area information for each of the plurality of display apparatus regardless of whether each of the display apparatus is operatively connected to the communication pathway.

10. The image display system according to claim 9, wherein the plurality of display apparatus include a first display apparatus and a second display apparatus, and the system further comprises:
a first display subsystem configured to create image information compatible with the first display apparatus;
a second display subsystem configured to create image information compatible with the second display apparatus;
a display apparatus disposition information storage unit configured to read and store display apparatus disposition information;
a screen area management subsystem configured to manage the first display subsystem, the second display subsystem, and the display apparatus disposition information;
a screen switching subsystem configured to switch image information from being provided to the second display subsystem to being provided to the first display subsystem; and
a reduced screen creation subsystem configured to receive image information from the screen switching subsystem and edit the image information to a reduced screen size prior to providing the image information to the first display subsystem.

11. The image display system according to claim 9, wherein the plurality of display apparatus include a first display apparatus and a second display apparatus, and the system further comprises:
a first display subsystem configured to create image information compatible with the first display apparatus;
a second display subsystem configured to create image information compatible with the second display apparatus;
a display apparatus disposition information storage unit configured to read and store display apparatus disposition information;
a screen area management subsystem configured to manage the first display subsystem, the second display subsystem, and the display apparatus disposition information;
a virtual screen display subsystem configured to receive image information for the second display subsystem, the image information from the virtual screen display apparatus being accessible by the first display subsystem; and
a reduced screen creation subsystem configured to receive image information from the virtual screen display subsystem and edit the image information to a reduced screen size prior to providing the image information to the first display subsystem.

12. The image display system according to claim 9, wherein at least one of the plurality of display apparatus is a projector.

13. The image display system according to claim 9, wherein a USB port is interposed in the communication pathway.

14. A computer program product embodied in at least one computer readable medium and comprising computer instructions executable by a computing device to perform the functions of:
displaying a first image information from the computing device on a first display apparatus;
determining whether a second display apparatus is operatively connected with the computing device;
if operatively connected, displaying a second image information to the second display apparatus;
if not operatively connected,
acquiring the second image information to be displayed on the second display apparatus, and
displaying the second image information on the first display apparatus.

15. The computer program product of claim 14, further comprising computer instructions executable by the computing device to perform the functions of:
reducing a screen size of the second image information prior to displaying the second image information on the first display apparatus; and
displaying the second image information on the first display apparatus concurrently with the first image information.

16. The computer program product of claim 14, further comprising computer instructions executable by the computing device to perform the function of:
receiving information descriptive of a display area for each of the first display apparatus and the second display apparatus;
managing the first image information and the second image information through a screen area management subsystem, the first image information and second image information being managed as integrated screen area information based on the information descriptive of the display area of the first display apparatus and the second display apparatus; and
processing the screen area information in accordance with display apparatus disposition information.
